(19) United States
(12) Patent Application Publication
(10) Pub. No.: US 2020/0125548 A1
(43) Pub. Date: Apr. 23, 2020

(54) EFFICIENT WRITE OPERATIONS FOR DATABASE MANAGEMENT SYSTEMS

(71) Applicant: Oracle International Corporation, Redwood Shores, CA (US)

(72) Inventors: Kamaljit Shergill, Maidenhead (GB); Michael Gleeson, Saratoga, CA (US); Tirthankar Lahiri, Palo Alto, CA (US)

(21) Appl. No.: 16/657,349

(22) Filed: Oct. 18, 2019

Related U.S. Application Data
(60) Provisional application No. 62/748,257, filed on Oct. 19, 2018.

(51) Int. Cl. G06F 16/22; G06F 16/23; G06F 16/2455

(52) U.S. Cl. CPC G06F 16/2282; G06F 16/24568; G06F 16/2379

(57) ABSTRACT

Techniques are described for performing optimized writes in the volatile memory of DBMS. In an embodiment, DBMS receives, from a client application of a computing device, a request to store a set of data entries for a database object. DBMS identifies at least one buffer in buffer memory in the volatile memory to write first set of data entries. A writer process of the DBMS writes first set of data entries in a buffer of the buffer memory in the volatile memory. Independently of the writer process, based on a buffer mapping data structure for the buffer memory, a flush coordinator process identifies a buffer chain of the buffer chains that includes the written buffer. A background flush process persistently stores first set of data entries from the buffer in the volatile memory to persistent storage of the DBMS. After the writer process wrote the first set of data entries in the buffer in the volatile memory but before the background flush process stored first set of data entries from the buffer to the persistent storage, DBMS sends an acknowledgement to the client application that the request to store the first set of data entries for the particular database object is successful.

### BENEFIT CLAIM

This application claims the benefit under 35 U.S.C. § 119(e) of provisional application 62/748,257, filed Oct. 19, 2018, the entire contents of which is hereby incorporated by reference for all purposes as if fully set forth herein.

### FIELD OF THE TECHNOLOGY

The present invention relates to the field of electronic database management, in particular to efficient write operations for database management systems.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

An increasing number of electronic devices that traditionally did not require network and thus were not networked, are now being connected to the Internet to substantially increase their effectiveness and usability. These electronic devices are colloquially referred to as the Internet of Things (IoT) devices. Generally, IoT devices have limited computational resources, such as processing power and storage. For this and other reasons, IoT devices use the Internet connection to connect to remote data stores such as database management systems (DBMS) and store information remotely.

The limited capabilities of the IoT devices prevent the IoT devices from utilizing DBMS client-side enhancements. One such enhancement in a DBMS client driver that an IoT device may be limited from utilizing is the capability of batching together individual updates. As part of a such enhancement, the client-side array accumulates data of individual insert operation requests, and then, the driver issues a single multi-row insert operation rather than issuing multiple single-row insert operations, thereby considerably saving computation/communication resources.

Even if such a client-driver were available for an IoT device, the IoT device would not be able to take advantage of this feature to amortize the cost of insert operations over many rows. Because of the limited computation resources, an IoT device fails to maintain the state of the application across multiple data generation cycles, and thus would not be able to perform bulk updates to the DBMS. Currently, IoT devices perform each update over a separate connection incurring delays for the devices and additional computational cost for the DBMS.

One approach to reducing delays for the IoT device is to configure the device to issue “fire and forget” single row inserts. For example, once a read of sensor data is performed, an insert operation for a single row of sensor data is issued by the IoT device.

However, when such an insert operation is issued to a DBMS, the DBMS treats the operation as any general update and thus incurs overhead such as buffer memory navigation, buffer pinning, transaction management, space management and redo logging.

For example, the DBMS has to process the “fire and forget” insert of a single row as a complete database transaction, invoking multiple layers of the DBMS that safeguard the integrity of the transaction and the data managed by the DBMS. Traversal of the full software stack of the DBMS for such an update has built-in safeguards and concurrency checks that are indispensable for the DBMS. However, such checks add bottlenecks to an IoT device-based system because the DBMS slows down the processing of the inserts. The IoT device has to wait for an acknowledgment from the DBMS for each “fire and forget” insert of a single row.

Accordingly, not only the DBMS incurs additional computation cost, but the resulting overhead of the DBMS processing causes a delay for the IoT device because has to wait for the acknowledgement of each insert of a single row, which is processed through the full stack of the DBMS. Thus, the existing client-server infrastructure may not be amenable to use for high-speed data entry updates to a database. Techniques are described herein to improve the throughput of streaming single/multiple row “fire and forget” insert operations and other technical problems described above.

### BRIEF DESCRIPTION OF THE DRAWINGS

In the drawings of certain embodiments in which like reference numerals refer to corresponding parts throughout the figures:

FIG. 1 is a block diagram that depicts a system for optimized storage of data entries generated at client devices, in one or more embodiments;

FIG. 2A-F is are block diagrams that depict buffer memory, in one or more embodiments;

FIG. 3 is a flowchart diagram that depicts a process for performing a write into buffer memory, in one or more embodiments;

FIG. 4 is a flow diagram that depicts a process for flushing buffers, in one or more embodiments;

FIG. 5 is a block diagram of a basic software system, in one or more embodiments;

FIG. 6 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, structures and devices are shown in block diagram form in order to avoid unnecessarily obscuring the present invention.

### General Overview

The approaches herein describe improvements to latency and resource utilization for data stream operations, such as updating a DBMS with data streams of sensor data received from IoT devices. A data stream may include one or more data entries of “fire and forget” operations. Each data entry is typically of a small size. The data entry may include data for a single row of a database table, or a portion thereof. However, the techniques described herein may be similarly applied to any size data of write operations such as on data entries with multiple rows of a table.

In an embodiment, multiple electronic devices are coupled to a mid-tier database application and request write operations. Examples of write operations include an insert or an update to a table maintained by the DBMS or operations that a mid-tier database application may readily translate into those of update or insert of data entries. The mid-tier database application aggregates the data entries of the connected device(s) into a stream of data entries. The stream of data entries may be aggregated based on the common target table of the operations and/or the target table(s) being optimized for stream-based operation. The mid-tier database application may be a client of the DBMS or maybe a part of the DBMS to which client devices directly issue operations for one or more data entries.

Upon receipt of a request with a stream of data entries from a mid-tier or a client device over an established session, the DBMS uses one or more data structures to store and manage the stream of data entries in its database server cache. The data structures facilitate the buffering of a stream of data entries in the database server cache, the volatile memory of the DBMS. In particular, the techniques include decoupling the acknowledgment of a successful write operation into the DBMS from the eventual persistence of the written data on the persistent storage of the DBMS.

The client receives the acknowledgment of the success for the issued operation when the stream of data entries is written to the buffer memory, in an embodiment. A set of buffers is allocated in a database server buffer memory to store the incoming stream(s) of data entries. In response to the received command(s) to store stream(s) of data entries, the database server stores the stream(s) in one or more buffers of the set of buffers. A stream of data entries may be stored in a database server buffer without taking any latches. In some embodiments, versioning techniques may be used to avoid the possibility of concurrent flushing or writing into the same buffer memory or a chunk of buffer memory.

The invocation of the components responsible for persisting the data occurs independently of the acknowledgment for the successful write operation. Stated differently, although the client of the DBMS may receive an acknowledgment for the requested write operation, the stream of the write operation may not be persistently stored in the storage of the DBMS.

The DBMS, independently from the storing streams into buffers, traverses the set of buffers to apply the data to the persistent storage in a deferred manner, asynchronous from the acknowledgment of the successful write operation. The persisting operation may be performed using multiple parallel processes to minimize any potential data loss due to a critical failure of the DBMS that could cause erasure of the server buffer memory.

### System Overview

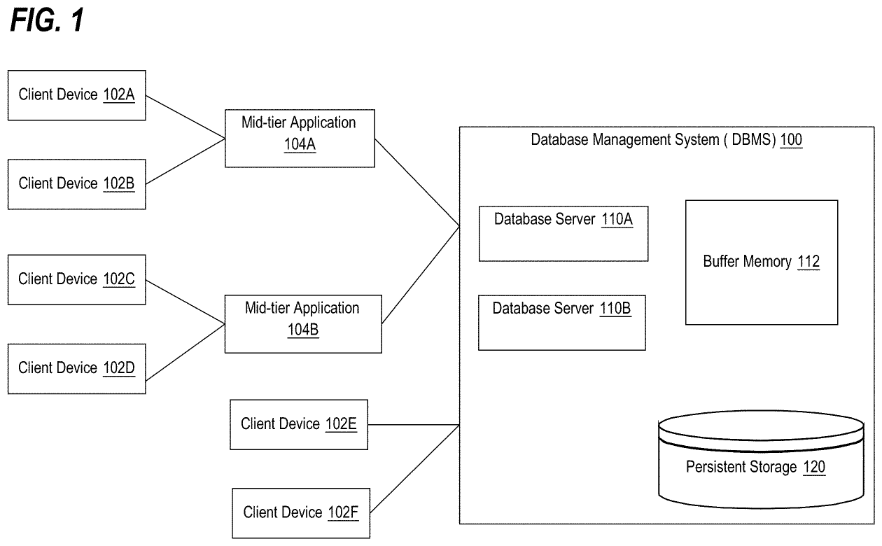

FIG. 1 is a block diagram that depicts a system for optimized storage of data entries generated at client devices, in one or more embodiments. In FIG. 1, client devices 102A . . . F are computing devices that generate data entries for storing at DBMS 100. Although only client devices 102A . . . F are depicted, in reality, there may be thousands or even millions of such devices directly or indirectly connected to DBMS 100. Client devices 102A . . . F may be smart home devices, machinery controllers and other IoT devices.

In an embodiment, client devices 102A . . . D are communicatively coupled to mid-tier applications 104A/B through a network such as the Internet. The client devices issue frequent write operations, such as inserts of new data entries, to mid-tier applications 104A/B. Each of mid-tier applications 104A/B may receive data entries from a particular set of client devices. For example, mid-tier application 104A processes data entries from client devices 102A/B, and mid-tier application 104B processes data entries from client devices 102C/D. Each mid-tier application may service a particular type of data entry generating client devices (e.g., based on purpose of client-devices, generated data entry data type, frequency of data generation).

The received data entries from client devices may be aggregated by a mid-tier application into a stream of data entries. As depicted in FIG. 1, mid-tier application 104A may be communicatively coupled with DBMS 100 and client devices 102A/B. Client devices 102A/B transmit data entries to mid-tier application 104A, which aggregates the data entries into a stream of data entries. Mid-tier application 104A requests storing the aggregated stream of data entries in DBMS 100.

Additionally or alternatively, client devices may directly request DBMS 100 to store generated data entries. Client devices 102E/F may aggregate data entries into a stream of data entries and directly send the streams to DBMS 100 for storage. The term “client application” refers herein to any mid-tier application, such as mid-tier applications 104A/B and/or any application on a client device, such as client devices 102E/F, that request a stream of data entries to be written in DBMS.

In an embodiment, database servers of DBMS 100 (110A and 110B) have access to a globally accessible cache area that includes buffer memory 112. Buffer memory 112 is a volatile, fast access memory that incurs little delay for write operations. Buffer memory 112 may be written to via remote direct memory access (RDMA) writes originated by mid-tier applications 104A/B or by a write request to database servers 110A/B from mid-tier applications 104A/B and/or client devices 102E/F. The term “writer process” refers to a database server process that performs the writing of a stream of data entries into buffer(s) of buffer memory 112, regardless of the manner and the source of the original write request.

From buffer memory 112, data in streams of data entries is persistently stored in persistent storage 120 of DBMS 100. In an embodiment, processes of database servers 110A/B read data from buffer memory 112 and persistently store data in persistent storage 120. Such processes may be different from the processes writing data into buffer memory 112 and maybe spawned independently thereof. The term “flush process” refers to a database server process that performs the persistent write of buffer data from buffer memory 112 into persistent storage 120.

### Optimized Write Request

In an embodiment, a request to DBMS 100 indicates that the request is for an optimized write of a stream of data entries. The term “optimized write” refers herein to a write operation that is performed on a volatile, fast access memory such as buffer memory 112 of DBMS 100 and for which persistence is asynchronous from the write and may be deferred. To designate to the DBMS that the request is for an optimized write, the request may include an additional indication to that effect. For example, in an SQL-based request, the request may include an SQL hint such, “MEMOPTIMZED_WRITE” to denote that the write request is for an optimized write. Additionally or alternatively, if the target data object(s), such as table(s), of the request are configured for optimized writes, then the request is executed as an optimized write. For example, the metadata of a table may include a property that may be configurable by a database administrator to indicate whether the table is configured for optimized writes.

### Buffer Memory Allocation

To process optimized writes, buffer memory is allocated to store stream(s) of data entries that are received by DBMS 100. In an embodiment, a database server allocates the memory for the buffer memory at the time of the first optimized write operation to write the first stream of data entries. When the request is received, DBMS 100 determines whether buffer memory exists to store the stream of data entries and if not, allocates the buffer memory before processing the optimized write request. Alternatively, the buffer memory is allocated at the startup of the DBMS. The memory for the buffer memory may be allocated from a large pool of memory, the size of which may be configured by a database administrator. In an embodiment, the buffer memory has a dynamic size area within the global area of the database server cache. The dynamic size may increase or decrease based on the relative rates of received write requests and the speed of concurrent free-up of the memory that persists the streams of the buffer memory.

DBMS 100 attempts to allocate the buffer memory in a set of as large as possible contiguous memory spaces from the global access area of the database server cache. DBMS 100 may request the largest memory space size possible, and if such an allocation fails, DBMS 100 loops into requesting half of the failed allocation request size until the allocation is successful. The allocated set of memory spaces are carved up into buffers and referenced by a buffer mapping data structure. For example, a 2 GB buffer memory may be divided into 1 MB buffers managed by a hash table, as a buffer mapping data structure.

### Buffers and Buffer Buckets

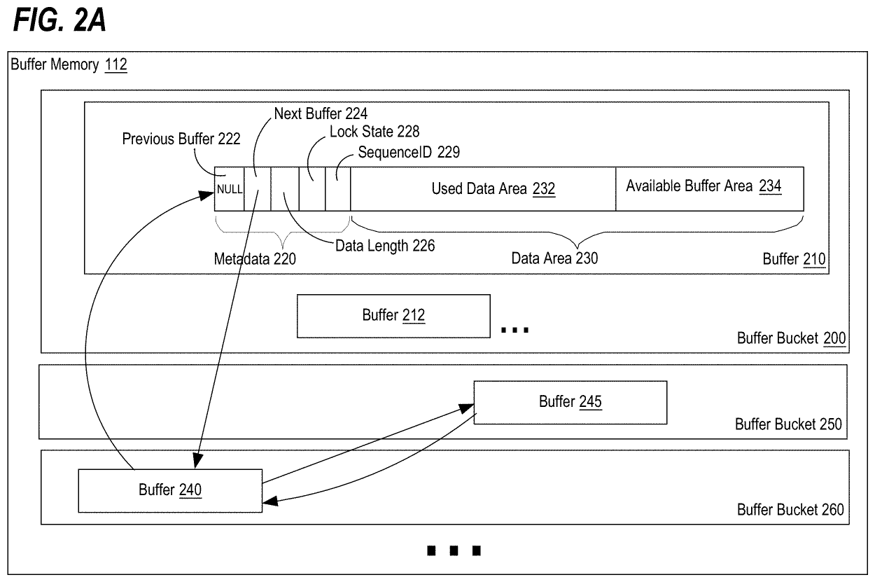

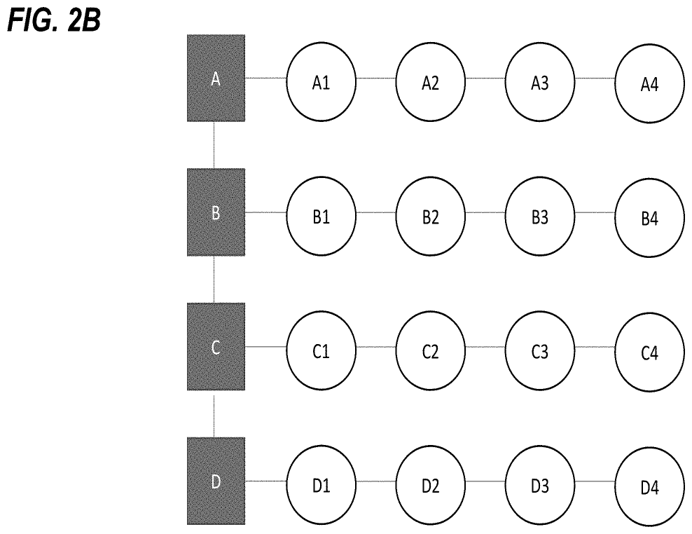

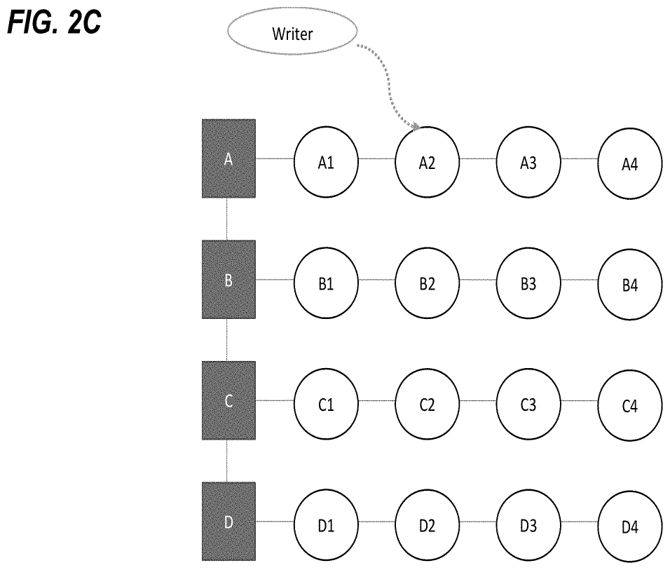

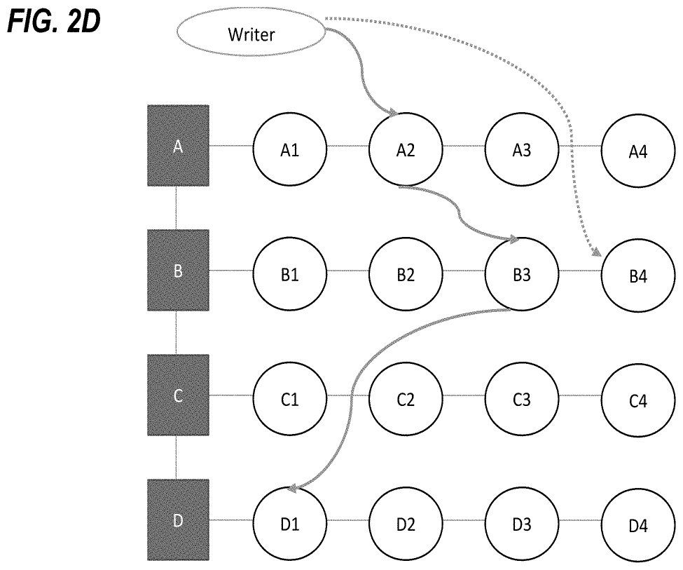

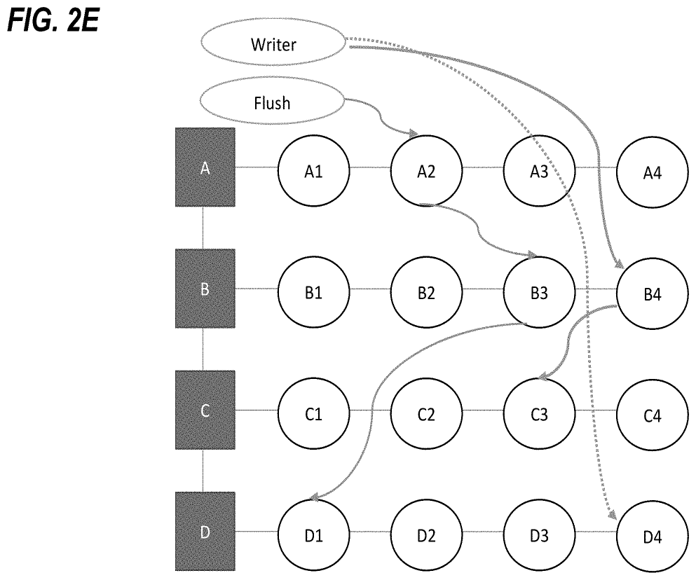

In an embodiment, a buffer contains metadata describing one or more of: the buffer size, the used and/or the available amount of memory in the buffer, the lock state of the buffer, references to the next and/or previous buffers in a chain of buffers. FIG. 2A is a block diagram that depicts buffer memory 112, in one or more embodiments. Buffer 210 has been allocated in buffer memory 112 according to techniques described herein. Buffer 210 includes two memory areas, metadata 220 and data area 230. Data area 230 is the area of the buffer in which optimized write operation stores data entry(s). Metadata 220 includes information about buffer 210, data stored in buffer 210 and pointers to one or more other allocated buffers, in an embodiment.

From metadata of a buffer, such as metadata 220 of buffer 210, the available or used memory amount of the buffer may be used to determine whether DBMS 100 can write received stream of data entries into the buffer. For example, data length 226 contains the number of addressable memory units (e.g., bytes, words) that are currently occupied by data, which, with the size of the buffer, can be used to determine the amount of available memory 234 in buffer 210. Used data area 232 represents the area of the buffer that is already occupied by the stored stream(s) of data entries.

The lock state, such as lock state 228, may be used to determine whether a database server process is writing into the buffer or not. In an embodiment, a database server process that has identified a buffer for an optimized write operation determines whether a lock exists on the buffer. The database server process locks the buffer as indicated by the buffer lock state. While the buffer is locked other processes, such as a flush process that writes to persistent storage 120, are prohibited from accessing the buffer. Such a process similarly checks the lock state of the buffer before determining to perform a flush (persistent write) of the buffer.

In one embodiment, the lock state for a buffer may be a bit, which is set (or alternatively reset) whenever a writer process is accessing the buffer and reset (or alternatively set) when the writer process completes the storing into the buffer. Additionally or alternatively, the lock state of a buffer is represented by a version identifier of the buffer in the metadata. The version identifier is incremented when the buffer is selected by a writer process and again incremented when the writer process completes the writing into the buffer. Accordingly, for example, if the version identifier of the buffer is odd, then the buffer is locked, and no flush process accesses it, and if the version identifier of the buffer is even, then the buffer can be accessed by a flush process.

In an embodiment, once the writer process completes storing a stream of data entries in a buffer for an optimized write request, the writer process generates a global sequence identifier for the buffer and stores the identifier in buffer metadata. SequenceID 229 of FIG. 2A represents such an identifier. The identifier temporally indicates the time the last optimized write in buffer 210 was completed compared to other optimized writes in buffer memory 112. SequenceID 229 may be the timestamp indicating DBMS 100's system time for the last completed optimized write for the buffer 210. DBMS 100 may maintain an aggregate of sequence identifiers for each session and/or target database object. For example, DBMS 100 may maintain the greatest sequence identifier of sequence identifiers of buffers that are associated with a particular session and/or a particular target database object. DBMS 100 may also maintain the least sequence identifier from sequence identifiers of buffers that are associated with a particular session and/or a particular target database object and that have been flushed to persistent storage.

The buffer metadata may maintain other information about the buffer: e.g., the identifier for the client that has locked the buffer; flush status indicating whether the buffer data has been flushed to persistent storage; process identifier for the writer process; information about the database object for which data entry(ies) are contained in the buffer; the optimized write's session identifier; number of rows written by the optimized write in the buffer; and number of columns written by the optimized write in the buffer.

In an embodiment, buffers may be arranged in a bucket of buffers. Buffers in contiguous memory space are grouped under a bucket of buffers. Each bucket of buffers may correspond to contiguous memory space in buffer memory that stores multiple buffers of known size (e.g., fixed size or a size known from the metadata of the buffer).

In an embodiment, buffer memory may contain multiple buffer buckets to improve search latency for available buffers for writer processes and/or to improve any collisions between processes servicing buffers. Continuing with FIG. 2A, buffer memory 112 includes buffer buckets 200, 250 and 260. Upon a receipt of an optimized write request, DBMS 100 may randomly select one of the buffer buckets in buffer memory 112 for the writer process servicing the request to store the stream(s) of data entries into a buffer of the selected buffer bucket.

In an embodiment, a buffer within a bucket may be associated with a particular session and/or a database object. In such an embodiment, when a buffer bucket is selected for a writer process servicing an optimized write request received through a particular session and/or targeting a particular database object, a pointer to the buffer is stored in the session. The stored pointer may be associated with a particular database object.

As another example, FIG. 2B depicts a buffer memory, in an embodiment. The buffer memory maintains multiple buffers for each of buckets A-D. The buffers for each of buckets A-D are allocated in the buffer memory, preferably contiguous. Bucket A references buffers A1-4, bucket B references buffers B1-4, bucket C references buffers C1-4, bucket D references buffers D1-4.

In an embodiment, when more than one buffers are used by a writer process, the writer process links the buffers into a chain. The buffers may be linked by one or more pointers in metadata, such as a next buffer reference and/or previous buffer reference. Continuing with FIG. 2A, in buffer bucket 200, buffer 210's next buffer reference 224 points to buffer 240 of buffer bucket 260, which itself points to buffer 245 as the next buffer in buffer bucket 250. The last/tail buffer has no next buffer reference (the reference is NULL). In an embodiment, buffer 245 has a previous buffer reference that points back to buffer 240 and buffer 240 has a previous buffer reference that points to buffer 210. Since buffer 210 is the first/head buffer, its previous buffer reference 222 has no reference (the reference is NULL).

### Writing to Buffers

A buffer mapping data structure arranges buffers for a write process to efficiently identify a buffer to perform an optimized write into. In an embodiment, a buffer mapping data structure is implemented as a hash table with each hash bucket referencing a buffer bucket. The hash bucket may also contain or reference the metadata about the corresponding buffer bucket. The bucket metadata may include one or more of: a reference to the most recent buffer used for the bucket as a hint for a writer process to find an available buffer, a latch for tracking if a writer process is currently writing into any of the buffers in the bucket, a client identifier that has written into the buffer chain.

The buffer mapping data structure may further maintain the head and tail buffer references for the buffers that have been used by the optimized write (referred herein as a “write chain”) for a particular database session and/or database object, and the head and tail buffer references for the buffers in a “ready to flush” state (also referred to as “flush queue”).

In an embodiment, performing an optimized write includes finding and reserving a buffer, and then writing to the buffer and any subsequent buffer(s) thereby generating a write chain of buffers. A buffer or the chain thereof may be exclusively used by that session for a given database object, and the address of the buffer is cached by the writer process performing the optimized write. The buffer is used until the buffer is full unless a flush process concurrently flushes the buffer, in an embodiment.

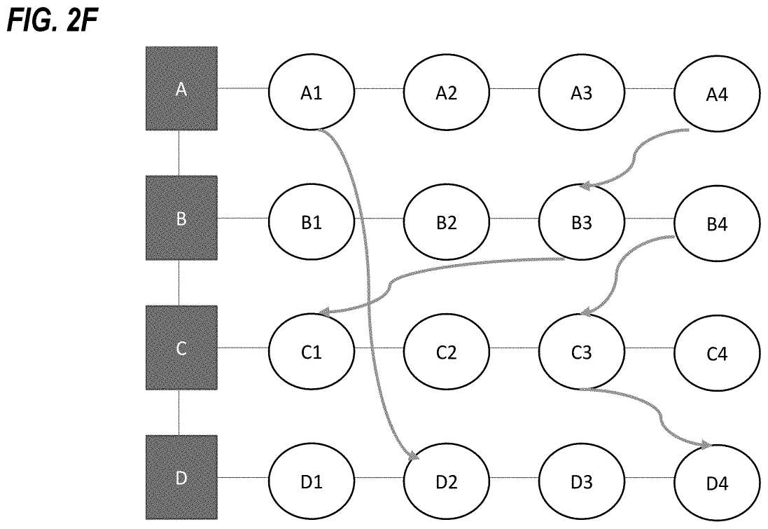

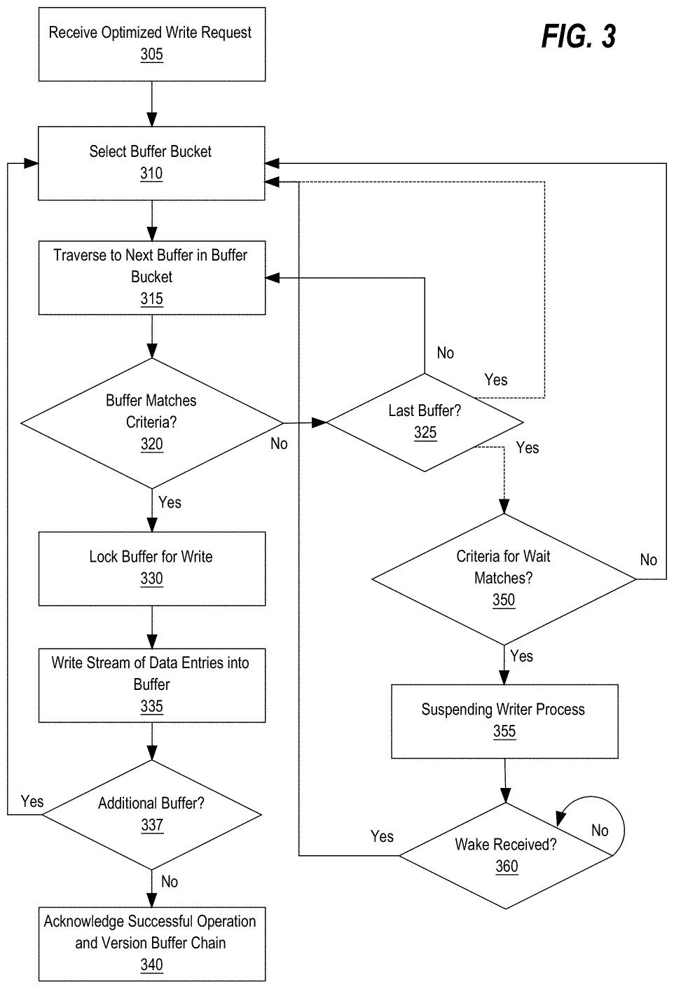

FIG. 3 is a flowchart diagram that depicts a process for performing a write into buffer memory 112, in one or more embodiments. One or more of the steps described below may be omitted, repeated, and/or performed in a different order. Accordingly, the specific arrangement of steps described should not be construed as limiting the scope of the invention. Further, the steps shown below may be modified based on the data structure used to store the data.

At step 305, DBMS 100 receives an optimized write request over a client session with DBMS 100. The optimized write request specifies the database object to be modified by the referenced stream of data entries. For example, the optimized write request may be an SQL statement such as the SQL statement below, which inserts a value of 1 using an optimized write into the database object of table “T.”

INSERT/*+MEMOPTIMIZE_WRITE*/INTO T VALUES (1)

Alternatively, a remote direct memory access (RDMA) write request is received for a memory address in allocated buffer memory 112. The write request may similarly specify the target database object for the optimized write.

A writer process of DMBS 100 services the received optimized write request. At step 310, the writer process selects a buffer bucket in buffer memory 112 to determine whether a suitable buffer exists for writing the stream of data entries into. The writer process may randomly select a buffer bucket to traverse for the determination.

In an embodiment, to select a buffer bucket, the writer process accesses a buffer mapping data structure for buffer memory 112 to select a buffer bucket in buffer memory 112. The writer process may use one or more identifiers (e.g. the session identifier or database object identifier) of the optimized write request to determine an entry of the buffer mapping data structure, thereby selecting the buffer bucket associated with the entry. To ensure randomness in selecting the entry of the buffer mapping data structure and thus the buffer bucket, the writer process may select the entry based on the current timestamp. The randomness reduces the chances for a collision of multiple writer processes selecting the same buffer bucket and improves the latency of a writer process in finding an available buffer, thereby improving the latency of the optimized write response.

In an example, the buffer mapping data structure is a hash table and each entry is a hash bucket of the hash table. The writer process performs a hash function on a combination of one or more identifiers such as the session identifier, the database identifier and the target database object identifier of the optimized write request to select a hash bucket (entry) in the hash table that corresponds to a buffer bucket. Randomness may be achieved by performing the hash function on the current timestamp in addition to one or more of the other identifiers. The generated hash (or modulo thereof) is used as an index into the hash table to select a hash bucket and thus, the corresponding buffer bucket.

In an embodiment, the writer process may request a latch on the buffer bucket. The latch may be used for the improbable case of another writer process selecting the same buffer bucket, which can cause a race condition for selecting the same buffer. Once an appropriate buffer is locked by the writer process or the buffer bucket is fully traversed, the latch is released.

At step 315, the writer process traverses the selected buffer bucket and, at step 320, evaluates criteria for selecting a buffer to write into for each buffer traversed. In an embodiment, to reduce the latency for the buffer bucket traversal, the writer process accesses the metadata for the buffer bucket to retrieve the last successfully written buffer reference. The writer process may traverse the buffer bucket at step 315, starting from the last successfully written buffer. Because the buffers are written into in sequential order of traversal, the last successfully written buffer provides a highly probative hint that the next buffer would be available for an optimized write.

In an embodiment in which the last successful buffer information is not present in the metadata or the last successful buffer is determined not to match the criteria at the next step 320, the writer process uses the memory offset to traverse to the next buffer of the buffer bucket.

At step 320, the writer process determines whether the current buffer being traversed is a suitable buffer for the optimized write. To do so, the writer process evaluates one or more predefined criteria for a suitable buffer against one or more buffer characteristics (such as those in the buffer metadata). The criteria for a suitable buffer include the existence of a lock on the buffer, current state of the buffer, and available memory space to write the data stream of the write request. For example, if the current state of the current buffer indicates ready to flush, then no further optimized writes may be performed to the current buffer. Similarly, if the available memory space in the buffer is not enough for the data entries of the data stream in the optimized write, then the buffer fails to qualify. The lock state indicating that another writer process is using the buffer or the buffer is being flushed may further disqualify the buffer.

By performing steps 315-320, the buffer bucket is traversed until either a suitable buffer is identified at step 320 or the last buffer of the bucket has been evaluated at step 325. If, at steps 320-325, the last buffer in the bucket is evaluated not to be suitable, then another buffer bucket is selected at step 310. The writer process may continue selecting another buffer bucket at step 310 until a buffer bucket with a suitable buffer is identified at step 320.

FIG. 2C is a block diagram that depicts a writer process selecting a buffer in a buffer memory for an optimized write, in an embodiment. The writer process randomly selects bucket A based on the described hash function. The process traverses the buffers of the bucket starting at either the beginning of the bucket or from a current buffer reference for the bucket based on a previous walk (e.g., the current buffer reference may be stored in the metadata of bucket A). The traversal is performed latchless in an embodiment. When a buffer is identified, then a latch is taken for a brief time to reserve the buffer. For example, the writer process may start from the beginning of the bucket and select buffer A1. Buffer A1 may not be suitable because it may not have enough available memory to store the received stream of data entries. The writer process traverses to buffer A2. The buffer A2 matches the criteria and thus is selected for the writer process to perform an optimized write.

In an embodiment, the writer process may determine that the traversal needs to be suspended to wait for newly available buffer(s). Accordingly, at step 350, the writer process evaluates criteria for suspending the traversal. Based on the evaluation, the writer process may proceed to select another buffer bucket at step 310, or suspend itself at step 355. The criteria may be based on the number of buffers or buffer buckets previously traversed. For example, after traversing at least two buckets without finding a suitable buffer to write into, the writer process enters a wait state to ensure that during such a wait state a new appropriate buffer is freed up by a flush process. At step 360, the writer process wakes up either after a pre-defined timeout, or if the writer process is posted by a flush process that had freed a buffer in that bucket. After waking, the process proceeds to select a new buffer bucket at step 310.

### Buffer Locking

Once a suitable buffer is identified by the writer process at step 320, the writer process proceeds to step 330 to acquire a lock on the buffer. In an embodiment, atomic increments of a counter, such as a version, in the header of the buffer are used to lock the buffer, and to indicate to other processes that the buffer is being written to or has changed since the previous access. Doing so synchronizes the access to the buffer between a writer process and a concurrent flush process.

In an embodiment, the writer process, performing the optimized write on a buffer, increments the version counter before the write. Whether the version number is odd or even determines whether there is an active optimized write being performed on the chunk. For example, if the version is an odd number, then the writer process is actively writing to the buffer, and if the version number is even, the flush process may proceed with persistently storing the stream of data entries stored in the buffer into persistent storage 120.

The version is again incremented after the write has been completed. In this example, the counter becomes an even number indicating no optimized write is being performed on the buffer. The version number after the increment may be saved in a local session state, so the session may check if the buffer is changed at a later time.

Continuing with FIG. 2C, buffer A2 is now the “current buffer” since the writer process has determined that buffer A2 has space for incoming writes. The reference to buffer A2 may be cached in the session state of the writer process for a quick lookup at the next write. As part of choosing a new buffer, the writer process increments the version of buffer A2 to indicate a lock on buffer A2 and updates the buffer mapping data structure which is shared with other writer and flush processes to record this current write buffer reference. Once the write is completed, the version is again incremented to indicate a release of the lock.

In an embodiment, continuing with FIG. 3, when a buffer becomes full at step 335 and the buffer state is changed to a “ready to flush” state, then there is no requirement to check the version number since there is no concurrency between a flush and a future writer process that may perform a write to the buffer.

In an embodiment, if a current buffer is evaluated to match the one or more criteria for flushing (even if the buffer is not full), then an optimized write may attempt to write to the buffer just as it begins to be flushed. To guard against this race condition, the flush process retrieves the version number of the buffer, and based on the version number determines whether an optimized write is being performed on the buffer. Similarly, if the flush process is the first one to access the buffer in such a race condition, the flush process determines, based on the buffer version to indicate that no optimized write is to be performed on the buffer. In such an example, the flush slave process may increment the buffer's version number to be odd to indicate to the writer process not to perform an optimized write on the buffer.

### Performing Write into Selected Buffer(s)

Continuing with FIG. 3, at step 335, the writer process writes the stream of data entries from the request into the selected buffer. At step 337, if the stream of data completely fills the selected buffer, the writer process marks the buffer as “ready to flush” and proceeds to step 310 to select a new buffer. The newly selected buffer is connected with the previously selected buffer through the next and/or previous buffer references, such as next buffer 224 of FIG. 2. The connected buffers form the write chain in which the head and tail buffer references are stored in buffer mapping data structure. Steps 310 to 337 are repeated until the stream of data entries of the request is completely stored within the multiple buffers forming the write chain of buffers.

FIG. 2D is a block diagram that depicts a writer process generating a write chain of buffers, in an embodiment. When the writer process filled buffer A2 with the received portion of data stream, the writer process randomly selects buffer B3 (as depicted in FIG. 3, from step 337, the process transitions to step 310 to select a new buffer). After filling B3, the writer process randomly selects buffer D1, and when buffer D1 is filled, the writer process selects buffer B4 and starts writing the remaining portion of the received stream of data entries into the buffer. While buffer B4 is being written into and is not full, buffer B4 is referenced as the current buffer and its reference is saved in the session metadata and bucket B metadata. Only after buffer B4 is full, buffer B4 may join the write chain.

Before then, buffer B4 is the current buffer in the buffer mapping data structure, and there is a “write chain” for buffers A2, B3 and D1, represented with write head reference to buffer A2 and write tail reference to buffer D1. The buffer mapping data structure may not need to store the references for the buffers in between the head and tail since the buffers are linked together through the buffer metadata next buffer and/or previous buffer references.

In an embodiment, if the last selected buffer to write the remaining stream of data entries is not the same as the buffer reference retrieved from buffer metadata to start the optimized write, the buffer metadata is updated to indicate the current buffer as the last successful write buffer.

Additionally or alternatively, the reference for the newly written buffer may also be saved in the metadata for the session of the optimized write request. Subsequent optimized writes from the same session may attempt to use the same buffer. Doing so improves the utilization of computational resources by avoiding a further search for another buffer to write data into.

Accordingly, the next optimized write of the same session may attempt to write into the same buffer (i.e., the last buffer written into for the last optimized write received in the same session) but after performing a check whether the metadata indicates that the buffer has not yet been flushed by a flush process or has not been used by another optimized writer process. In such an embodiment, if the buffer bucket metadata or buffer metadata indicates that the buffer has been flushed by storing the data to persistent storage 120 and/or the buffer has been re-used by another session, the writer process searches for a new buffer

The writer process may further check if the next optimized write is for the same database object as assigned to the buffer. If the buffer has not been flushed and is assigned to the same database object of the next optimized write, then the next optimized write stores at least a portion of its stream of data entries in the same buffer.

Additionally, the writer process for the next optimized write of the session may determine whether the buffer version has not changed since the last time the session wrote to the buffer. A version change may indicate that the buffer is locked for flushing or for writing and the concurrent flush process is persistently storing the buffer to persistent storage 120, as discussed above. If so, the writer process foregoes re-using the same buffer for the next optimized write.

The writer process may also search for another buffer if the buffer metadata indicates that there is insufficient free memory space for the stream of data entries of the new optimized write to be stored in the buffer. For example, based on data length 226 of buffer 210 which was assigned to the particular session and the database object, the writer process may determine that available buffer area 234 is not large enough to store the new request's stream of data entries. In such an embodiment, the writer process may update the metadata to indicate that the buffer is in a “ready to be flush” state. For example, the tail pointer of the write chain may be updated with the buffer reference of buffer 210 to indicate that buffer 210 is ready to be flushed.

In the case in which the new optimized write is for a different database object, then the writer process, using techniques described herein, checks other buffers for the session, to determine whether a buffer for this different object already exists, in an embodiment. If no other buffer exists for the new database object, the writer process may re-use any of the previously used buffers for the session for the new optimized write request. Such an approach avoids spending additional computational resources for getting a new buffer when a previously used one still has free space, even though the optimized write is for a different database object. The buffer reference (whether for the new or the already identified buffer for the session) may be cached in the session memory for subsequent optimized writes for the new database object from the session to avoid the buffer management data structure lookup.

Continuing with FIG. 3, at step 340, DBMS 100 acknowledges the success of the optimized write after successfully storing the stream of data entries of the request into one or more buffers of the buffer bucket(s). In an embodiment, the DBMS 100 acknowledges the successful write operation for writing the stream of data entries at the time when the stream is only written to buffer memory 112 and may not yet be persisted in persistent storage 120. Accordingly, the acknowledgment for the successful write is sent by DBMS 100 independent whether any flush process has persisted the data of the request. The client application that initiated the request may receive the response that the write operation is successful, while the data has not yet been persisted on persistent storage 120.

### Durability of Optimized Write

If a critical failure occurs at DBMS 100 that causes a reset of volatile memory such as buffer memory 112, the successfully acknowledged write transaction's data may be lost from buffer memory 112 without being persisted on persistent storage 120. To alleviate this concern, DBMS 100 provides information to the client application about the persistence of buffers to enable client-side recovery.

For example, writer process(es), at step 340, generate and store a new version number for each optimized write to the buffer using atomically increasing sequence number. The writer process may update the metadata of the buffer with the version number and may return the version number to the client application as part of the acknowledgment. Alternatively or additionally, the writer process may return the client application the buffer identification number for the buffer with which the client application may query DBMS 100 for the version of the buffer.

Independently from writer process(es), when a flush process flushes a buffer to persistent storage 120, the flush process may record the current version number of the buffer flushed. DBMS 100 maintains the flushed version numbers of buffers in associations with the respective identifiers of buffers, in an embodiment. Accordingly, the client application may query with the buffer identifier for which an optimized write has been performed and receive an indication of whether the buffer has been flushed. The client may use such information for client-side recovery of data loss.

As part of a client-side recovery of data loss, the client application may maintain a local copy of the stream of data entries even after the optimized write to buffer memory 112 has been issued and acknowledged as successful. The client application may request the status of the durability of the optimized write, i.e., whether the DBMS has flushed the chunk to the persistent storage. When the DBMS stores the buffer data of the requested optimized write to the persistent storage, the DBMS may confirm the persistence to the client application. The client application may then discard the stream(s) of data entries associated with the optimized write.

In an embodiment, DBMS 100 maintains a single versioning scheme for buffer memory 112. In such an embodiment, buffer version numbers are increasing across the buffer memory based on the timestamp at which optimized write(s) are performed. A global atomic counter (such as those based on global timestamp) may be used for versioning the buffers across buffer memory 112.

In an embodiment, DBMS 100 maintains the maximum version number for the buffers that have been flushed within buffer memory 112. When a flush process completes persisting the stream(s) of entries from a buffer to persistent storage 120, the flush process updates the maximum version number only if the flushed buffer version number is greater than the previously maintained maximum version number. The client application may compare the acknowledged buffer version number with the maximum flushed buffer version number to determine whether the acknowledged buffer has already been flushed. If the maximum flushed buffer version is lesser or equal to the acknowledged buffer version number, then the optimized write of the client for the buffer has not been persisted in persistent storage 120. If the maximum flushed buffer version is greater, then the optimized write may have been persisted in persistent storage. Any stream of data entries that have been cached on the client-side for a replay of the optimized write in case of critical failure of DBMS 100 may be discarded.

### Consistency of Optimized Write

In an embodiment, the optimized write may contain multiple operations that are inter-dependent such as a parent-child operation relationship. DBMS 100, upon the identification of such a relationship within the optimized write, may not execute the child operation until the parent operation is confirmed as successful. Examples of such a dependency are foreign key inserts and intervening updates of rows inserted via the buffer memory.

In an embodiment, there may be multiple write operations in an optimized write to the buffer memory. In case some of the operations on the row(s) produce error(s), such as a primary key violation, while other data of the operations are successfully persisted, the failing rows will be logged in an error table. The client application originating the optimized write may query the error table for status and replay the corresponding operations.

### Persistent Flush Functional Overview

To persist acknowledged optimized writes, one or more flush processes of DBMS 100 traverse the buffers of buffer memory 112 and, based on the buffer state, persist the stream(s) of data entries in the buffer to persistent storage 120. As described above, once a buffer is full, then the buffer is indicated with the status of “ready to flush” in the buffer metadata. In an embodiment, the buffers in the write chain between the head reference and the tail reference of the write chain have a status of ready to flush. The flush process reassigns the head and tail references to the flush queue for the buffers to be flushed. Alternatively, the coordinator flush process traverses the write chain of the buffer memory and adds the buffers with the ready to flush state to the flush queue to be flushed.

In an embodiment, using the buffer memory management data structure, DBMS 100 persists the stream of data entries of the performed optimized writes based on the association of each write chain in the buffer memory management data structure. For example, if the buffer memory management data structure associates write chains with sessions, then DBMS 100 may flush buffers to persistent storage 120 per session. Similarly, if the data structure is indexed based on a database object identifier (e.g., per database table), then DBMS 100 may flush buffers of buffer memory 112 per a database object.

Additionally or alternatively, a buffer may be identified for flushing based on time triggers. If a buffer has not been written into by an optimized writer process for a pre-configured time-period, the buffer may be moved to the flush queue or flushed by a posted flush process. Such a buffer may have free space but the session (and/or the database object) assigned to the buffer may not be receiving any additional optimized write requests. To free buffer memory 112 and to ensure persistence of data in persistent storage 120, a partially full buffer has a time trigger, which if not reset by optimized a writer process, triggers a flashing process after the pre-configured time-period expires.

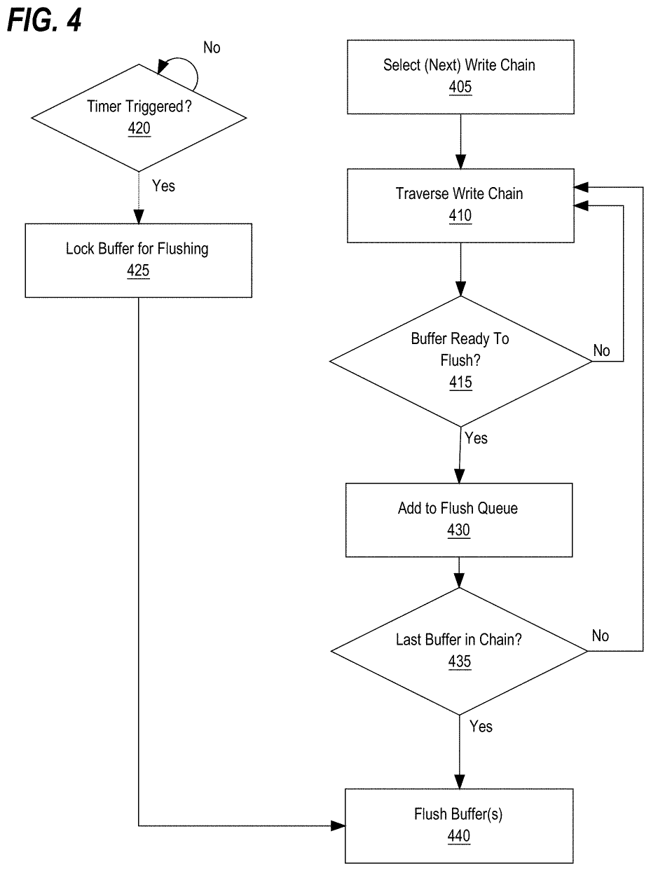

FIG. 4 is a flow diagram that depicts a process for flushing buffers, in one or more embodiments. At step 420, after an optimized write has written into a buffer, a time trigger for a pre-defined time period is set on a buffer to determine whether any writer process is still using the buffer to store stream(s) of data entries. If any optimized writer process fails to write into the buffer before the time out period of the timer expires, then, at step 425, the buffer is triggered to be locked for flushing either by incrementing the buffer version and/or updating the buffer status in the metadata. Once locked, the process transitions to step 440 to cause the flushing of the buffer.

In an embodiment, flushing is performed by a coordinator flush process and slave flush processes. The coordinator processor may use the buffer management data structure to determine which chain to flush. Alternative to steps 410-432 of FIG. 4 described below, the flush coordinator process may assume that if a buffer is in the write chain, then the buffer is in the ready to flush state. Accordingly, the flush coordinator process moves the portion of the write chain between the tail and head referenced buffers to the flush queue.

In an alternative embodiment, continuing with FIG. 4, at step 405, a coordinator flush process selects a write chain based on the index granularity of buffer management data structure. For example, when a session with a client is closed, DBMS 100 may spawn a flush coordinator process to flush the buffer chain(s) associated with the closed session. The session identifier is used to retrieve one or more references to the buffer chain(s) for the session.

At step 410, the flush coordinator process retrieves the head buffer reference of the write chain from the metadata of the selected buffer chain. The process selects the head buffer to determine whether the buffer has a “ready to flush” state. At step 415, if it is determined that the state indicates that the buffer may be flushed, the buffer is added to the flush queue at step 430. The flush coordinator may traverse till the last buffer in the chain, as determined at step 435, performing steps 410-435 for each buffer in the chain.

In an embodiment, at step 440, flush slave process(es) flush the flush queue independent of the flush coordinator process. This approach frees the coordinator flush process to continue traversing the buffer management data structure for other buffers that indicate readiness to be flushed to persistent storage.

FIG. 2E is a block diagram that depicts a flush process generating a flush queue from a write chain, in an embodiment. Once a flash coordinator process identifies a write chain in a buffer mapping data structures, one or more flush slaves identify buffers A2, B3, D1 of the write chain as indicated with the status of ready to flush. These buffers are split from the write chain and form the flush queue. Buffer B4 and any other buffers concurrently written to by the writer process remain in the write chain. For example, buffers B4, C3 remain in the write chain. Buffer D4 is now indicated as the current buffer for the session to write into.

If no buffer is found with a “ready to flush” state in the buffer management data structure at step 415, then the coordinator enters a wait, waking after a timeout or being posted. If a buffer is identified with a “ready to flush” state, then the coordinator flush process adds the buffer to the flush queue for persisting the stream(s) of data entries.

FIG. 2F is a block diagram that depicts writer process(es) re-using flushed buffers in existing and/or new write chains of buffers, in an embodiment. Buffers A2, B3, and D1 have been flushed and freed by the flush process(es). Once flushed, other writer processes may select any of these buffers to write into and append to their respective write chains. For example, buffer B3 that used to be part of the flush chain as depicted in FIG. 2E, is now part of the write chain that includes buffers A4, B3 and C1, as depicted in FIG. 2F. Eventually each of the depicted write chains is converted to a flush chain and flushed in parallel by flush slave processes.

### Database Management System Overview

A database management system (DBMS) manages a database. A DBMS may comprise one or more database servers. A database comprises database data and a database dictionary that are stored on a persistent memory mechanism, such as a set of hard disks. Database data may be stored in one or more data containers. Each container contains records. The data within each record is organized into one or more fields. In relational DBMS's, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology.

Users interact with a database server of a DBMS by submitting to the database server commands that cause the database server to perform operations on data stored in a database. A user may be one or more applications running on a client computer that interact with a database server. Multiple users may also be referred to herein collectively as a user.

As used herein, “query” refers to a database command and maybe in the form of a database statement that conforms to a database language. In one embodiment, a database language for expressing the query is the Structured Query Language (SQL). There are many different versions of SQL, some versions are standard and some proprietary, and there are a variety of extensions. Data definition language (“DDL”) commands are issued to a database server to create or configure database objects, such as tables, views, or complex data types. SQL/XML is a common extension of SQL used when manipulating XML data in an object-relational database. Although the embodiments of the invention are described herein using the term “SQL,” the invention is not limited to just this particular database query language and may be used in conjunction with other database query languages and constructs.

A client may issue a series of requests, such as requests for execution of queries, to a database server by establishing a database session, referred to herein as “session.” A session comprises a particular connection established for a client to a database server, such as a database instance, through which the client may issue a series of requests. The database server may maintain session state data about the session. The session state data reflects the current state of the session and may contain the identity of the user for which the session is established, services used by the user, instances of object types, language and character set data, statistics about resource usage for the session, temporary variable values generated by processes executing software within the session, and storage for cursors and variables and other information. The session state data may also contain execution plan parameters configured for the session.

Database services are associated with sessions maintained by a DBMS with clients. Services can be defined in a data dictionary using data definition language (DDL) statements. A client request to establish a session may specify a service. Such a request is referred to herein as a request for the service. Services may also be assigned in other ways, for example, based on user authentication with a DBMS. The DBMS directs requests for a service to a database server that has been assigned to running that service. The one or more computing nodes hosting the database server are referred to as running or hosting the service. A service is assigned, at run-time, to a node in order to have the node host the service. A service may also be associated with service-level agreements, which are used to assign a number of nodes to services and allocate resources within nodes for those services. A DBMS may migrate or move a service from one database server to another database server that may run on a different one or more computing nodes. The DBMS may do so by assigning the service to be run on the other database server. The DBMS may also redirect requests for the service to the other database server after the assignment. In an embodiment, after successfully migrating the service to the other database server, the DBMS may halt the service running in the original database server.

A multi-node database management system is made up of interconnected nodes that share access to the same database. Typically, the nodes are interconnected via a network and share access, in varying degrees, to shared storage, e.g., shared access to a set of disk drives and data blocks stored thereon. The nodes in a multi-node database system may be in the form of a group of computers (e.g., workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system may be allocated to running a particular database server's software. Each combination of the software and allocation of resources from a node is a server that is referred to herein as a “server instance” or “instance.” A database server may comprise multiple database instances, some or all of which are running on separate computers, including separate server blades.

### Software Overview

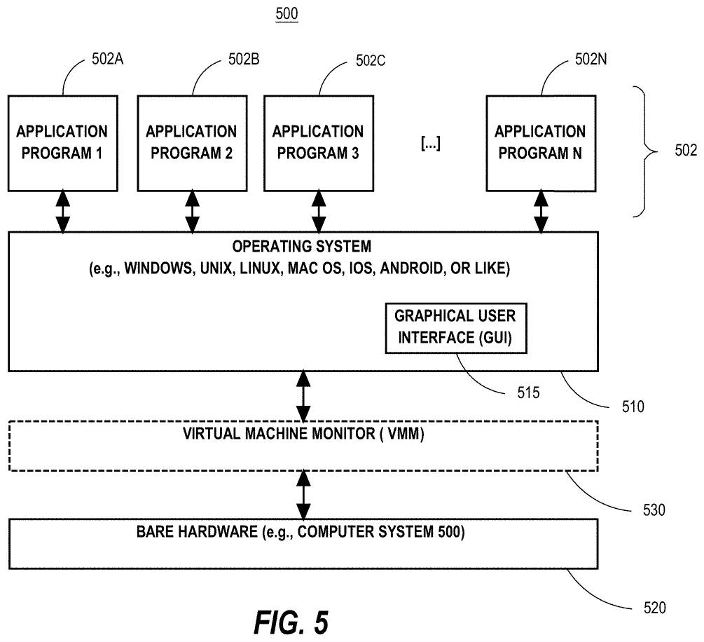

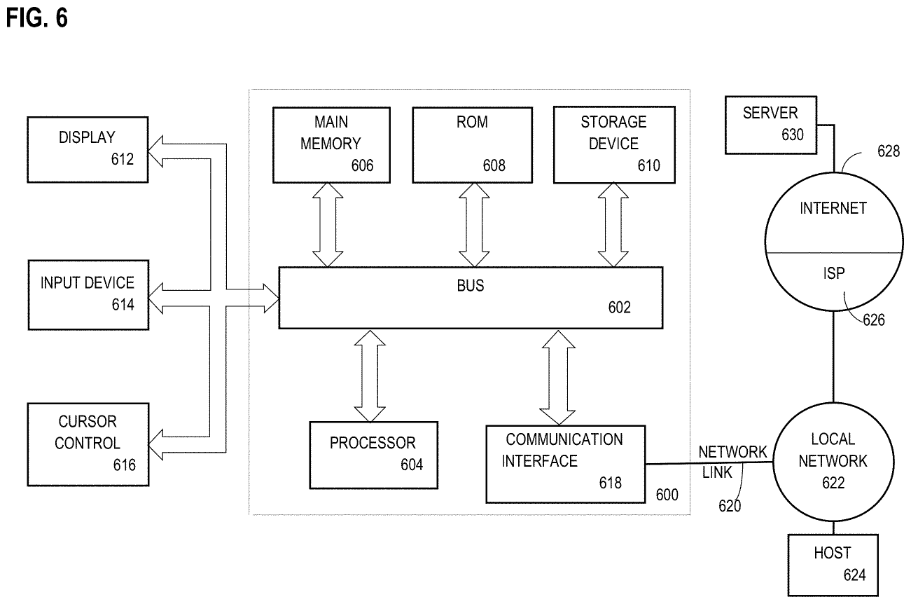

FIG. 5 is a block diagram of a basic software system 500 that may be employed for controlling the operation of computing system 600 of FIG. 6. Software system 500 and its components, including their connections, relationships, and functions, are meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 600. Software system 500, which may be stored in system memory (RAM) 606 and on fixed storage (e.g., hard disk or flash memory) 610, includes a kernel or operating system (OS) 510.

The OS 510 manages low-level aspects of computer operation, including managing execution of processes, memory allocation, file input and output (I/O), and device I/O. One or more application programs represented as 502A, 502B, 502C . . . 502N, may be “loaded” (e.g., transferred from fixed storage 610 into memory 606) for execution by the system 500. The applications or other software intended for use on computer system 600 may also be stored as a set of downloadable computer-executable instructions, for example, for downloading and installation from an Internet location (e.g., a Web server, an app store, or another online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 604) of computer system 600. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 600.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 600 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system and may run under the control of other programs being executed on the computer system.

Multiple threads may run within a process. Each thread also comprises an allotment of hardware processing time but share access to the memory allotted to the process. The memory is used to store the content of processors between the allotments when the thread is not running. The term thread may also be used to refer to a computer system process in multiple threads are not running.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers. In a cloud computing environment, there is no insight into the application or the application data. For a disconnection-requiring planned operation, with techniques discussed herein, it is possible to release and then to later rebalance sessions with no disruption to applications.

The above-described basic computer hardware and software and cloud computing environment presented for the purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field-programmable gate arrays (FPGAs) that are persistently programmed to perform the techniques, or may include one or more general-purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices, or any other device that incorporates hard-wired and/or program logic to implement the techniques.

For example, FIG. 6 is a block diagram that illustrates a computer system 600 upon which an embodiment of the invention may be implemented. Computer system 600 includes a bus 602 or another communication mechanism for communicating information, and a hardware processor 604 coupled with bus 602 for processing information. Hardware processor 604 may be, for example, a general-purpose microprocessor.

Computer system 600 also includes a main memory 606, such as a random access memory (RAM) or another dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read-only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal, and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic, or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626, in turn, provides data communication services through the world wide packet data communication network now commonly referred to as the “Internet” 628. Local network 622 and Internet 628 both use electrical, electromagnetic, or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620, and communication interface 618. In the Internet example, a server 630 might transmit a requested code for an application program through Internet 628, ISP 626, local network 622 and communication interface 618.

The received code may be executed by processor 604 as it is received, and/or stored in storage device 610 or other non-volatile storage for later execution.

### Computing Nodes and Clusters

A computing node is a combination of one or more hardware processors that each share access to a byte-addressable memory. Each hardware processor is electronically coupled to registers on the same chip of the hardware processor and is capable of executing an instruction that references a memory address in the addressable memory, and that causes the hardware processor to load data at that memory address into any of the registers. In addition, a hardware processor may have access to its separate exclusive memory that is not accessible to other processors. The one or more hardware processors may be running under the control of the same operating system

A hardware processor may comprise multiple core processors on the same chip, each core processor (“core”) being capable of separately executing a machine code instruction within the same clock cycles as another of the multiple cores. Each core processor may be electronically coupled to connect to a scratchpad memory that cannot be accessed by any other core processor of the multiple core processors.

A cluster comprises computing nodes that each communicate with each other via a network. Each node in a cluster may be coupled to a network card or a network-integrated circuit on the same board of the computing node. Network communication between any two nodes occurs via the network card or network integrated circuit on one of the nodes and a network card or network integrated circuit of another of the nodes. The network may be configured to support remote direct memory access.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
receiving, from a client application of a computing device, a request, at a database management system (DBMS), to store a first set of data entries for a particular database object;
a first process of the DBMS writing the first set of data entries in a first buffer of buffer memory in volatile memory;
a second process of the DBMS, different from the first process, persistently storing first set of data entries from the first buffer in the volatile memory to persistent storage of the DBMS;
after the first process writing first set of data entries in the first buffer in the volatile memory and before the second process storing first set of data entries from the first buffer in the volatile memory to the persistent storage of the DBMS, in response to the request, sending an acknowledgement to the client application that the request to store the first set of data entries for the particular database object is successful.

2. The method of claim 1, further comprising:
based on a buffer mapping data structure that references a plurality of buckets of buffer memory in volatile memory, identifying a first bucket of the plurality of buckets;
wherein each bucket of the plurality of buckets comprises one or more buffers and metadata thereof;
identifying the first buffer from the first bucket in the buffer memory to write the first set of data entries.

3. The method of claim 2, wherein the buffer mapping data structure comprises a plurality of entries, each entry corresponding to a respective bucket in the plurality of buckets, the method further comprising:
based on the request, the first process identifying a particular entry in the buffer mapping data structure which corresponds to the first bucket;
the first process identifying the first buffer in the buffer memory in the volatile memory to write first set of data entries at least by traversing one or more buffers of the first bucket;
wherein the first buffer matched criteria for writing the first set of data entries.

4. The method of claim 2, wherein the request includes a second set of data entries, the method further comprising:
after the first process writing first set of data entries in the first buffer in the volatile memory, determining that the first buffer is full;
identifying a second bucket of the plurality of buckets;
identifying a second buffer from the second bucket in the buffer memory to write the second set of data entries;
the first process of the DBMS writing the second set of data entries in the second buffer of the buffer memory in the volatile memory;
generating at least one reference from the first buffer of the first bucket to the second buffer of the second bucket;
wherein, using the at least one reference, a process traverses from the first buffer to the second buffer.

5. The method of claim 2, wherein identifying the first bucket of the plurality of buckets comprises:
transforming an identifier of a session through which the request was received or an identifier for the particular database object or both to generate a transformed identifier;
based on the transformed identifier, selecting a particular entry of the buffer mapping data structure that corresponds to the first bucket.

6. The method of claim 1, wherein the first buffer includes metadata describing one or more of: a size of the first buffer, a used amount of memory of the first buffer, a available amount of memory of the first buffer, a lock state of the first buffer, a reference to a next buffer to the first buffer in a buffer chain, and a reference to a previous buffer of the first buffer in a buffer chain.

7. The method of claim 1, wherein identifying the first buffer in the buffer memory in the volatile memory comprises:
the first process evaluating criteria for selecting the first buffer by determining that first set of data entries can be written in available space of the first buffer.

8. The method of claim 1, wherein identifying the first buffer in the buffer memory in the volatile memory comprises:
the first process evaluating criteria for selecting the first buffer by determining that a lock state of the first buffer indicates that the first buffer is available for writing first set of data entries in the first buffer.

9. The method of claim 8, wherein the lock state of the first buffer is determined by a value of a version identifier of the first buffer.

10. The method of claim 1, further comprising:
determining that no buffer memory exists in the volatile memory;
based on determining that no buffer memory exists, allocating the buffer memory in the volatile memory of the DBMS by allocating buffers in the buffer memory;
wherein each contiguous memory space in the buffer memory is allocated for a buffer.

11. The method of claim 1, further comprising:
detecting that the first buffer has not been modified for a particular time period;
based on detecting that the first buffer has not been modified for the particular time period, causing the second process to persistently store first set of data entries from the first buffer in the volatile memory to the persistent storage of the DBMS.

12. The method of claim 1, wherein metadata of the first buffer has an indication that the first buffer is ready to be stored persistently, the method further comprising:
based on the indication modifying a queue of buffers for persistently storing in the persistent storage to include the first buffer;
the second process traversing the queue of buffers to persistently store first set of data entries from the first buffer in the volatile memory to the persistent storage of the DBMS.

13. One or more non-transitory computer-readable media storing a set of instructions, wherein the set of instructions includes instructions, which when executed by one or more hardware processors, cause:
receiving, from a client application of a computing device, a request, at a database management system (DBMS), to store a first set of data entries for a particular database object;
a first process of the DBMS writing the first set of data entries in a first buffer of buffer memory in volatile memory;
a second process of the DBMS, different from the first process, persistently storing first set of data entries from the first buffer in the volatile memory to persistent storage of the DBMS;
after the first process writing first set of data entries in the first buffer in the volatile memory and before the second process storing first set of data entries from the first buffer in the volatile memory to the persistent storage of the DBMS, in response to the request, sending an acknowledgement to the client application that the request to store the first set of data entries for the particular database object is successful.

14. The one or more non-transitory computer-readable media of claim 13, wherein the set of instructions further includes instructions, which when executed by said one or more hardware processors, cause:
based on a buffer mapping data structure that references a plurality of buckets of buffer memory in volatile memory, identifying a first bucket of the plurality of buckets;
wherein each bucket of the plurality of buckets comprises one or more buffers and metadata thereof;
identifying the first buffer from the first bucket in the buffer memory to write the first set of data entries.

15. The one or more non-transitory computer-readable media of claim 14, wherein the buffer mapping data structure comprises a plurality of entries, each entry corresponding to a respective bucket in the plurality of buckets, and wherein the set of instructions further includes instructions, which when executed by said one or more hardware processors, cause:
based on the request, the first process identifying a particular entry in the buffer mapping data structure which corresponds to the first bucket;
the first process identifying the first buffer in the buffer memory in the volatile memory to write first set of data entries at least by traversing one or more buffers of the first bucket;
wherein the first buffer matched criteria for writing the first set of data entries.

16. The one or more non-transitory computer-readable media of claim 14, wherein the request includes a second set of data entries, and wherein the set of instructions further includes instructions, which when executed by said one or more hardware processors, cause:
after the first process writing first set of data entries in the first buffer in the volatile memory, determining that the first buffer is full;
identifying a second bucket of the plurality of buckets;
identifying a second buffer from the second bucket in the buffer memory to write the second set of data entries;
the first process of the DBMS writing the second set of data entries in the second buffer of the buffer memory in the volatile memory;
generating at least one reference from the first buffer of the first bucket to the second buffer of the second bucket;
wherein, using the at least one reference, a process traverses from the first buffer to the second buffer.

17. The one or more non-transitory computer-readable media of claim 14, wherein the set of instructions further includes instructions, which when executed by said one or more hardware processors, cause:
transforming an identifier of a session through which the request was received or an identifier for the particular database object or both to generate a transformed identifier;
based on the transformed identifier, selecting a particular entry of the buffer mapping data structure that corresponds to the first bucket.

18. The one or more non-transitory computer-readable media of claim 13, wherein the set of instructions further includes instructions, which when executed by said one or more hardware processors, cause:
the first process evaluating criteria for selecting the first buffer by determining that first set of data entries can be written in available space of the first buffer.

19. The one or more non-transitory computer-readable media of claim 13, wherein the set of instructions further includes instructions, which when executed by said one or more hardware processors, cause:
the first process evaluating criteria for selecting the first buffer by determining that a lock state of the first buffer indicates that the first buffer is available for writing first set of data entries in the first buffer.

20. The one or more non-transitory computer-readable media of claim 13, wherein the set of instructions further includes instructions, which when executed by said one or more hardware processors, cause:
detecting that the first buffer has not been modified for a particular time period;
based on detecting that the first buffer has not been modified for the particular time period, causing the second process to persistently store first set of data entries from the first buffer in the volatile memory to the persistent storage of the DBMS.
